(19) United States
(12) Patent Application Publication
(10) Pub. No.: US 2022/0256779 A1
(43) Pub. Date: Aug. 18, 2022

(54) SYSTEM FOR MANAGING AN AGRICULTURAL OPEN SPACE

(71) Applicant: AgroSolar Europe GmbH, Steinhofel (DE)

(72) Inventors: Markus Haastert, Steinhofel (DE); Franz Hilber, Trins (AT)

(73) Assignee: AgroSolar Europe GmbH, Steinhofel (DE)

(21) Appl. No.: 17/673,970

(22) Filed: Feb. 17, 2022

(30) Foreign Application Priority Data
Feb. 18, 2021 (DE) 20 2021 100 803.2
Mar. 11, 2021 (DE) 10 2021 202 392.4

(51) Int. Cl. A01G 9/24; H02S 20/32

(52) U.S. Cl. CPC A01G 9/243; H02S 20/32

(57) ABSTRACT

The invention relates to a system (10) for managing an agricultural open space (12), having:
at least two guide rail arrangements (11) running parallel to one another;
a processing device (24) supported on both guide rail arrangements (22) and being able to be moved along the guide rail arrangements (22);
at least one solar panel arrangement (28) arranged above the guide rail arrangements (22) and the processing device (24).

The invention relates to a system for managing an agricultural open space or, in other words, an agricultural surface. In particular, the invention relates to a system for at least partially automatic management of the agricultural open space. Management can comprise energy generation by means of solar panels (photovoltaic modules) and agricultural use through plant cultivation.

Various approaches exist in the prior art for at least partially automating the management of agricultural open spaces. A distinction must be made between solutions for automated plant breeding in greenhouses, for example, solutions relating to “vertical farming”. In the latter case, there are usually factory-like conditions that entail limited challenges for equipping with automation technology.

In comparison, the management of agricultural open spaces poses greater challenges for automation. In addition to the mostly much larger areas to be managed, there are greater weather influences. Furthermore, the natural soil has to be worked and not, as in automated greenhouses, for example, a standardized planter. Furthermore, environmental damage caused by the installation or use of technical systems in nature must be taken into account.

Previous approaches to automating agriculture outdoors mostly relate to autonomously driving vehicles, for example, robots or at least partly autonomously driving tractors or combine harvesters. These solutions are not always characterized by desired reliability and efficiency.

The object of the invention is generally to provide a technical solution for, in particular, at least partially automatic management of agricultural open spaces. This preferably has high reliability, efficiency and also environmental compatibility.

A system that can be installed at least temporarily on an agricultural open space (for example, a field or farmland) is generally proposed. The installation is preferably carried out such that the system can be dismantled with little effort, in particular without leaving permanent structures, such as foundations, supports or pillars, behind in the open space. This increases environmental compatibility.

The system is characterized by guide rail arrangements on which a processing device is movably guided. The processing device can also be referred to as a processing robot or generally as a robot. Said processing device preferably enabler automatic processing of the open space and plants growing thereon, for example, according to programmed work processes.

Processing can be understood as direct action on the open spaces and/or the plants planted thereon (for example, by irrigation, UV light irradiation or mechanical action). Additionally or alternatively, this can be understood to mean a sensory surveying of the open space and/or the plants planted thereon, for example, by means of camera sensors. Specific processing steps can be derived based on the sensory surveying, the processing steps preferably being executed at least partially by the processing device.

Furthermore, the system comprises a solar panel arrangement (or, in other words, an arrangement of photovoltaic modules). Said solar panel arrangement is preferably arranged above the guide rail arrangements and the processing device. Furthermore, it preferably covers or, in other words, at least partially covers a surface area within which the processing device moves.

Electrical energy can be obtained by means of the solar panel arrangement, the energy being able be used directly, for example, to operate electrical components of the system, in particular to operate the processing device. Additionally or alternatively, it is also possible to feed the electrical energy obtained at least partially into a power grid.

The solar panel arrangement can be at least partially transparent or, in other words, translucent. For this purpose, individual components having low translucency (for example, individual solar cell surfaces) can be spaced apart from one another such that translucent surface areas are present between them. However, the solar panel arrangement can also comprise transparent thin-film solar modules characterized by a high degree of transparency.

It has been shown that a microclimate advantageous for plant growth can be achieved by arranging the solar panels above the processed area. For example, a kind of greenhouse effect can be achieved in this way. In addition, unfavorable weather conditions such as rain, hail or strong winds can be at least partially reduced.

The solar panel arrangement can be flat and/or comprise a plurality of individual solar panels or photovoltaic modules. Said panels or modules can, for example, be arranged next to one another, in a planar manner and/or in the manner of a grid within the solar panel arrangement. The solar panel arrangement can be dimensioned and/or arranged such that it bridges at least half or essentially the entire distance between the guide rail arrangements. This can be the case in particular when the solar panel arrangement is held by means of two supporting structures explained below, the supporting structures each being supported on one of the guide rail arrangements.

Optionally, the solar panel arrangement can be pivoted by a motor. As a result, a so-called tracking function can be provided in order to adapt the alignment of the solar panel arrangement to the changing position of the sun during the day.

Additionally or alternatively, the light intensity on the soil below the solar panel arrangement can be controlled in this way. Depending on the angle of inclination and alignment to the sun, the ground can be covered or shaded to varying degrees by the solar panel arrangement, so that the incidence of light can be controlled there. For the same reason, inclination adjustment can help protect against the weather (particularly rain, snow, or hail). The larger the angle to the ground, the larger the area of the ground that can be covered by the solar panel arrangement with respect to weather influences. The inclination can generally be adjusted depending on the needs of the plants below, for example, for light or rainwater.

The system preferably has a plurality of solar panel arrangements. Said solar panel arrangements can be arranged one after the other along the guide rail arrangements, optionally at a distance from one another.

A flexible web, a net and/or a tarpaulin made of, for example, plastic or a fabric can be stretched on at least one solar panel arrangement (and preferably stretched between two solar panel arrangements). Said web can be under slight tension (for example, sag under its own weight). As a result, said web can form a concave receiving space for at least temporarily collecting and possibly draining rainwater or snow, for example. An intermediate space between two adjacent solar panel arrangements can be bridged at least in sections by means of such a web in order to protect a soil area underneath from the effects of the weather, such as driving rain or hail. Any collected water can be directed to a (preferably stationary) water storage device disclosed herein.

The solar panel arrangements can also have other, in particular permanently installed, water collection and/or water drainage devices. This allows rainwater to be channeled from the surface of the solar panel arrangement and preferably into a water storage device of the system. For example, channels can be arranged on at least one outer edge of the solar panel arrangements in order to catch water flowing down and drain said water off in a defined manner.

Naturally, more than two guide rail arrangements can also be provided. In particular, a plurality of pairs of guide rail arrangements can be provided, it being possible for all guide rail arrangements to run essentially parallel to one another. The pairs of guide rail arrangements can generally be positioned in a row-like manner side by side. Each pair of guide rail arrangements can have or guide a processing device of the type described herein. Said processing device can process a portion of the open space delimited on both sides by the guide rail arrangements. Each pair of guide rail arrangements can support at least one solar panel arrangement and/or a surface area of the open space delimited by the guide rail arrangements can be covered by at least one (and preferably a plurality of lined-up) solar panel arrangements.

A pair of guide rail arrangements can generally be understood to mean a pair of interacting guide rail arrangements. The interaction can consist in the fact that the guide rail arrangements are set up, due to their relative arrangement and/or extension, to jointly (that is, in particular simultaneously) support a processing device, for example, when said processing device moves along the guide rail arrangements.

A single guide rail arrangement can also be part of a plurality of corresponding pairs, for example, if it is positioned between two other guide rail arrangements and is set up to jointly support and guide a processing device with each of them. For this purpose, the guide rail arrangement can have a guide surface for a processing device, for example, in the form of a toothed rack or (rolling) rail, for example, on two outer sides facing away from one another.

Inexpensive automatic agricultural land management can be achieved using the system disclosed herein, the energy costs of which are low. Furthermore, the system can be erected with little effort and preferably also dismantled with little effort. In particular, it may not be necessary to provide permanent structures such as concrete foundations or pillars, which can at best be removed again with a great deal of mechanical effort and/or only by destruction.

In particular, a system for (preferably at least partially automatic) management of an agricultural open space is proposed, having:

at least two guide rail arrangements running parallel to one another;

a processing device supported on both guide rail arrangements and preferably extending at least in sections between them and being able to be moved (preferably automatically) along the guide rail arrangements;

a solar panel arrangement arranged above the guide rail arrangements and the processing device.

The guide rail arrangements can each be elongate in form. Each form a coherent elongated rail body. The guide rail arrangements can be arranged at a distance of, for example, at least one meter or at least two meters from one another. For example, the guide rail arrangements may be at least 10 meters or at least 30 meters long.

The guide rail arrangements can (viewed in a cross-sectional plane running orthogonally to their longitudinal axis) have an open cross-sectional profile, in particular an upwardly open and/or U-shaped cross-sectional profile. In other words, the cross-sectional profiles can each be elongated troughs in form.

For example, the guide rail arrangements can each have a bottom surface that faces the ground or rests directly thereon. Furthermore, they may have side wall areas extending at an angle to the soil area and/or connected to outer edges of the bottom surface. A connection to an optional ground anchor, as described below, can be established via the bottom surface. Likewise, an optional support structure for the solar panel arrangement can be fastened to the soil area and/or at least one side wall area.

The guide rail arrangements and/or at least guide surfaces attached thereto (for example, comprising a toothed rack or rail) for guiding the processing device can be adjustable in height. The height can be adjusted by means of actuators, for example, by means of lifting cylinders. However, manual adjustment is also possible, for example, by pulling out and mechanically locking the guide surfaces at different heights. An adjustment can be made to a vegetation height that increases over time by means of the height adjustment, so that the processing device remains at a sufficient distance from the vegetation. On the other hand, this ensures that when the vegetation height is low, sufficient proximity to the vegetation can be established in order to be able to process it suitably and/or survey it by sensors. This would be more difficult if the processing device were guided from the outset at a distance from the ground designed for a maximum vegetation height, which can also be provided to achieve a simple construction.

At least one of the guide rail arrangements can have a device for transmitting electrical energy to the processing device. This can be, for example, a conductor rail or an inductive energy transmission device. The processing device can receive electrical energy via this, in particular for locomotion and/or for carrying out desired processing processes. The required capacities of electrical energy stores of the processing device can be reduced as a result, since this can preferably be supplied with electrical energy over long distances and/or permanently via the electrical connection to the guide rail arrangement.

According to a preferred variant, the guide rail arrangements rest at least in sections on the open space or, in other words, on a soil or ground. In particular, in a preferably planar configuration of a soil area of the guide rail arrangements, said guide rail arrangements can thus be supported over a planar area. This increases stability, particularly when the guide rail arrangements support the solar panel arrangements and the processing device. Furthermore, fewer or no separate support structures for supporting the guide rail arrangements relative to the ground can then be required, which saves costs and improves dismantling.

The processing device can be supported on both guide rail arrangements, that is, in particular can be movably mounted on both ends of the guide rail arrangements. The processing device can bridge an intermediate space between the guide rail arrangements and thus a surface area of the open space delimited on both sides. The processing device can have a drive device on at least one contact area with one of the guide rail arrangements, by means of which it can generate a locomotion force while being supported on the (static) guide rail arrangement. In particular, the drive device can have a driven gear wheel which engages in a toothed rack of the guide rail arrangement.

According to a preferred variant, the solar panel arrangement is supported by at least one support structure on at least one of the guide rail arrangements. The support structure can consequently provide a supporting or holding function, by means of which the solar panel arrangement can be held and/or bedded above the guide rails. The support structure can be in one or more parts. It can be composed of metal profiles. It can extend upwards, starting from a guide rail arrangement to which it is preferably attached and, in particular, screwed. For example, it can arrange or hold the solar panel arrangement at a height of at least two or also at least five or also up to ten meters (or more) above the guide rail arrangement.

The support structure can have, for example, at least one pillar or at least two support legs fastened to one another and running at an angle to one another. Preferably, each solar panel arrangement is supported by at least two support structures preferably attached to adjacent guide rail arrangements.

According to one embodiment, the system has at least one electrical energy store for storing electrical energy generated by the solar panel arrangement (for example, a battery or an accumulator). The energy store can be attached to one of the system components described herein, in particular to a guide rail arrangement, a support structure or a solar panel arrangement. However, it can also be provided independently thereof and preferably outside the managed area (that is, outside the area which can be processed by the processing device).

The energy store can be at least temporarily connected to an energy store of the processing device and feed said energy store. The processing device can draw energy from its energy store for generating locomotion forces and/or for providing its functions described herein.

The energy store can have at least one electrical switching device and/or at least one power converter (for example, an inverter and/or rectifier). Current fed in or drawn can be converted to a desired level and/or in a desired manner in this way.

The solar panel arrangement and/or the optional energy store is/are preferably dimensioned and/or designed such that an amount of energy sufficient for the operation of the system (in particular the processing device) can be provided. In general, the system can be operated without an external electrical energy supply (that is, autonomously). Optionally, however, an external electrical power supply can be provided, that is, connected to the power grid.

However, this is preferably switched on temporarily only when insufficient energy is generated by means of the solar panel arrangement.

Additionally or alternatively, the system can have at least one water reservoir. Said water reservoir can be attached to one of the system components described herein, in particular to a guide rail arrangement or a support structure. However, it can also be provided independently thereof and preferably outside the managed area. The processing device can preferably be filled with water from the water reservoir. For example, said processing device can move to a predetermined position at which it connects to a fluid-conducting interface in order to conduct water from the preferably larger (system) water reservoir into its own water reservoir. To provide an irrigation function, the processing device can draw water from its own water reservoir until it is empty and a new refilling process becomes necessary.

As explained, the solar panel arrangement can at least partially cover or, in other words, roof over an area within which the processing device can be moved. If, as is generally preferred, a plurality of consecutive solar panel arrangements are provided, then a cumulative surface area of a surface that can be processed by the processing device and which is covered by the solar panel arrangements is preferably greater than a cumulative surface area that is not covered.

According to a preferred variant, the processing device comprises at least one of the following units:
an irrigation unit for watering the open space (and consequently also plants growing thereon);
a camera sensor for surveying the open space (and consequently also plants growing thereon);
a UV-C light source for illuminating plants with UV-C light;
a weed removal device for the preferential mechanical removal of weeds (for example, as opposed to removal by means of pesticides);
a humidity sensor (for example, for determining microclimate and/or determining an adjustment of solar panel inclination);
a nutrient sensor (for example, for determining a need for fertilization, wherein fertilizer can generally be supplied via the processing device);
a soil sensor, in particular for determining a humus layer thickness. The soil sensor can, for example, measure a distance between the sensor and the soil surface and thus conclude that a layer of humus has grown (with respect to a previous reference state).

Optionally, soil processing equipment can also be provided on the processing device, for example, plows or rakes. In this context, it may be necessary to design the guide rail arrangements with increased stability for the expected high processing forces.

All of these units or only those selected can be encompassed in a movable processing head of the processing device. Said processing head can be moved along a (bridge) section extending between the guide rail arrangements. It can be moved to a position that is currently relevant for processing and carry out the processing there.

In particular, it can be provided that the processing device is constructed in two parts, at least to the extent that it has a crossbeam arrangement and a processing head that can be moved thereto. The crossbeam arrangement can be aligned transversely to a longitudinal axis of the guide rail arrangements and/or connect adjacent guide rail arrangements. Said crossbeam arrangement can have a drive device for moving along the guide rail arrangements.

In particular, the processing head can be set up to change from one crossbeam arrangement to another crossbeam arrangement. In particular, said processing head can independently change to a crossbeam arrangement (for example, by driving onto it) which is provided on or at an adjacent pair of guide rails. As a result, the processing device can, so to speak, be selectively (completely) formed or provided on said adjacent pair of guide rails.

Changing or moving over to another crossbeam can take place transversely to a longitudinal axis of the guide rail arrangements. The crossbeams can then serve as primary or exclusive guide rails during the changing process. It is also possible to connect adjacent guide rail arrangements via separate changing paths, in particular curved paths, on which the processing device can move to an adjacent pair.

Due to a corresponding mobility or changeability of the processing head, a row currently processed thereby and/or a processed soil area can be changed as required, without the system having to have a plurality of corresponding processing heads from the outset.

Within the scope of the disclosure, only the processing head can also be understood as a processing device, so in particular protruding crossbeams cannot form part of the actual processing device. However, the processing head can still be supported on the guide rail arrangements via the crossbeams.

In summary, one development provides that at least two pairs of guide rail arrangements are provided, the guide rail arrangements of a respective pair being set up to interact to guide the processing device, at least part of the processing device (for example, the above processing head) being set up to change between said pairs (for example, by connecting to crossbeams of the above type that remain permanently there, if necessary).

Additionally or alternatively, at least the units listed above can be individually attached statically to the processing device, but then preferably in plurality. For example, a plurality of irrigation units (for example, irrigation nozzles or sprinklers) can be distributed along the processing device. A distance between such distributed units can be adapted to the distance between individual rows of plants.

Naturally, any combination of units can also be provided, which on the one hand, is attached to a processing head and on the other hand, is distributed immovably along the processing device.

The UV-C light source can irradiate plants grown in the open space with UV-C light. Said UV-C light can protect the plants from fungal attack due to its microorganism-decomposing effect.

The weed removal device can be or comprise a preferably movable device for mechanically removing weeds. For example, it can be a cutting or gripping device with which weeds can be mechanically separated and thus removed. Weeds can be detected by means of the camera sensor and image evaluation algorithms known in the prior art and the weed removal device can be aligned and/or controlled based thereon.

The guide rail arrangements can each have a plurality of consecutive rail segments. The rail segments can be attached to each other mechanically, for example, by means of screw connections. In principle, the rail segments can each be designed in the same way. Said rail segments can have a length of several tens of centimeters and for example, at least 50 cm.

A toothed rack, which is characterized by a significantly greater length, can be attached to the connected rail segments, the toothed rack bridging a plurality of or even all of the rail segments. Alternatively, the rail segments can each already have toothed rack sections that can be connected to form a continuous rack when the rail segments are connected.

Manufacturing and transport costs are reduced by using such segments. Furthermore, a flexible and needs-based design of the guide rail arrangements is made possible.

As mentioned, according to a further embodiment, at least one of the guide rail arrangements can have a toothed rack, in which a driven gear wheel of the processing device engages to generate a displacement movement. A rail can also be provided, on which the driven wheel of the processing device rolls.

Furthermore, as also already indicated above, the guide rail arrangements can rest on a ground at least in sections and/or be detachably held on the ground.

In particular, the guide rail arrangements can be fastened to a ground anchor (for example, screwed thereto). The ground anchor is preferably introduced into the soil of the open space and/or can be detached therefrom without being destroyed. In particular, the ground anchor may not comprise any foundations or concrete blocks placed in the soil. Instead, said ground anchor can be a so-called spinning anchor, as disclosed in EP 3 108 187 B1, for example. Accordingly, the ground anchor can have a plurality of rods which, starting from a base body resting on the soil, extend into the soil. The rods can have a length of at least half a meter and can be pivoted relative to one another. The base body and in particular a guide rail arrangement attached thereto can be held on the soil in this way. The rods can be unscrewed from the soil to loosen the ground anchor. The number, inclination and/or length of the rods can be selected depending on the soil conditions and the system weight to be secured.

Additionally or alternatively, the guide rail arrangements can rest on the bottom surface under their own weight and can thereby be secured to it. In particular, the guide rail arrangements can be filled with a suitable ballast material, for example, with stones, earth, crushed stone or gravel. Such material can advantageously be removed without leaving any residue during dismantling.

In general, the guide rail arrangements may be used as a form of raised bed and/or flower strip (that is, for planting flowering and/or insect friendly plants) during use of the system or thereafter. In this context, it is particularly advantageous if the ballast material (for example, according to the above variants) can also be used as a substrate for the flower strip. The guide rail arrangements can consequently be designed as a trough at least in sections and/or be used as a trough. Consequently, said troughs preferably do not represent pure construction areas, but can be used as a plant trough and can preferably also be filled with a suitable plant substrate for this purpose. The trough shape can comprise an elongate recess or indentation facing or opening into the upper side of a guide rail arrangement and can be filled therefrom. A side wall height and/or depth of the trough shape can be at least 10 cm and more preferably at least 20 cm.

Embodiments of the invention are explained below with reference to the accompanying schematic figures.

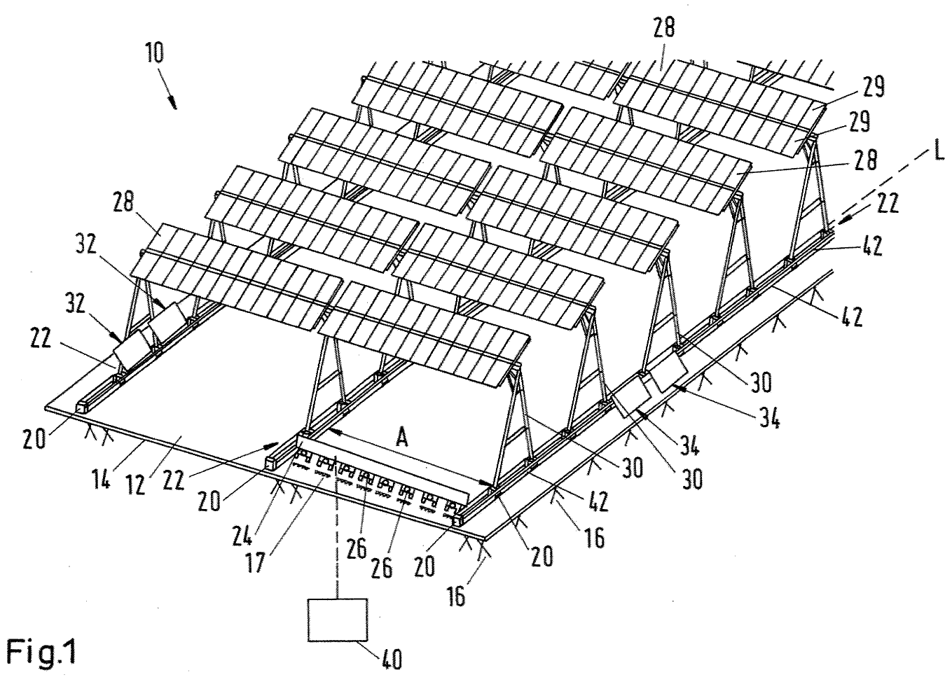

FIG. 1 shows a perspective partial view of a system according to an embodiment.

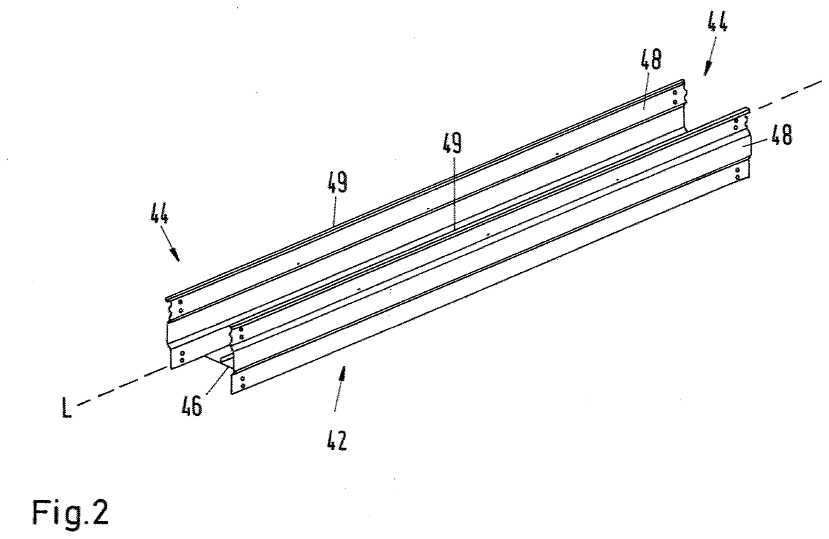

FIG. 2 shows a detailed view of an individual rail segment from a guide rail arrangement of the system.

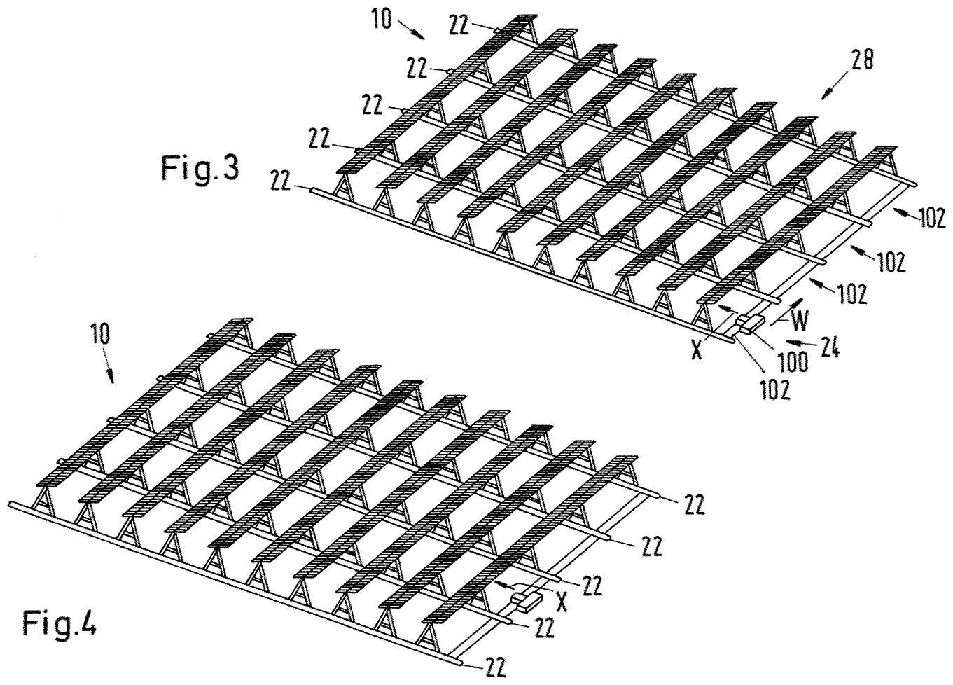

FIGS. 3-4 show perspective views of a system according to a further embodiment, different positions of a processing device being shown;

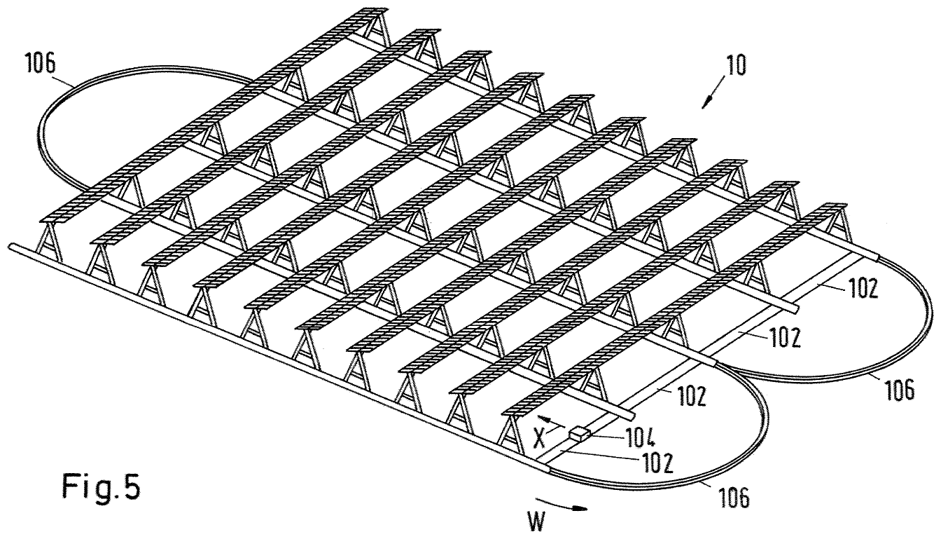

FIG. 5 shows a perspective view of a system according to yet further embodiment having an integrated row changing option for a processing device;

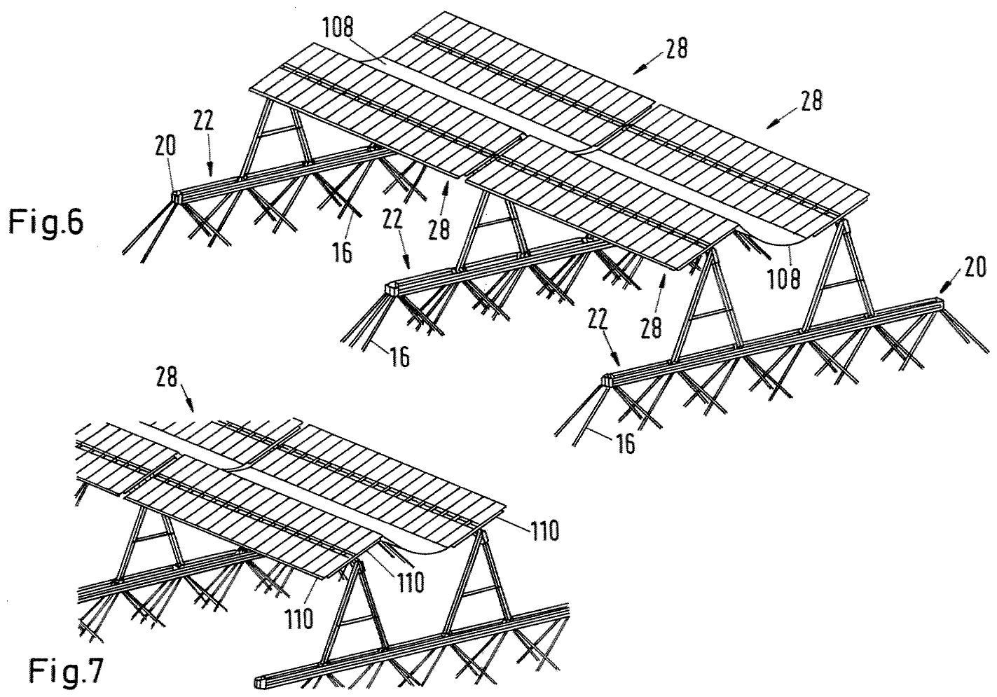

FIGS. 6-7 show detailed views of a system according to yet further embodiment having (protective) webs stretched between adjacent solar panel arrangements.

FIG. 1 shows a system 10 according to an embodiment of the invention. The system 10 is not depicted in its entirety, but rather extends beyond the portion shown. Individual parts of the system 10 are therefore not depicted in full or are cut off.

The system 10 is used to manage an agricultural open space 12. Of said open space, only a soil surface 14 is depicted schematically, but not underlying soil layers, so that components (rods 16) of ground anchors 20 explained below that extend therein can be seen uncovered.

Plants 17 cultivated on the open space 12 are indicated in an exemplary area (not all of them are provided with their own reference numbers). The entire open space 12 is preferably covered with corresponding plants 17.

The system 10 comprises at least two parallel guide rail arrangements 22. These are generally elongate in form, a longitudinal axis L being entered for one of the guide rail arrangements 22. Each two guide rail arrangements 22 interact such that they guide a processing device 24 explained below. The guide rail arrangements 22 of a correspondingly interacting pair are spaced apart from one another by a distance A of, for example, at least 1 m.

In the example shown, the central guide rail arrangement 22 interacts with both outer guide rail arrangements 22 in the manner described, since guide surfaces for supporting a processing device 4 are formed on both of its outer sides (see discussion of FIG. 2 below).

Naturally, a plurality of such interacting pairs of guide rail arrangements 22, together with the processing devices 24 guided therein, can be positioned next to one another, as is correspondingly indicated in FIG. 1. Thus, a plurality of rows of interacting guide rail arrangements 22 can be formed in order to cover a surface area of the open space 12 that is to be processed.

In the example shown, the guide rail arrangements 22 rest on largely concealed ground anchors 20, some of the positions of which are marked with reference numbers and result from the positions of their rods 16. For reasons of clarity, not all of the rods 16 in FIG. 1 are provided with a separate reference number.

Additionally or alternatively, the guide rail arrangements 22 rest on the soil surface 14 at least in sections. The proportions in FIG. 1 show that a soil surface 12 covered by the guide rail arrangements 22 is small. Preferably, said surface is less wide than the tire footprint of a conventional tractor. The system 10 is thus characterized by a high utilization of land for agricultural management.

The guide rail arrangements 22 are composed of a plurality of individual rail segments 42, one of which is explained below with reference to FIG. 2.

The processing device 24, which is only depicted as an example for the right interacting pair of guide rail arrangements 22, bridges the distance A between said guide rail arrangements 22. Said processing device is supported on both sides or, in other words, on both ends of the guide rail arrangements 22. In doing so, said processing device engages in toothed racks of the guide rail arrangements 22 (not depicted) via driven gear wheels (not visible). As a result, the processing device 24 can move along the guide rail arrangements 22 (more precisely along their longitudinal axis L).

A plurality of functional units 26 distributed along the processing device 24 are indicated (not all of them are provided with their own reference numbers). This can be any of the units explained in the general part of the description, for example, irrigation devices, weed removal devices or UV-C light sources.

A water reservoir of the processing device 24 and an electrical energy store thereof are not shown separately. These can generally be moved together with the processing device 24.

The system 10 also has a plurality of solar panel arrangements 28 (not all of them are provided with their own reference numbers). Each solar panel arrangement 28 consists of a planar arrangement of a plurality of individual solar panels 29 (not all of them are provided with their own reference numbers). The solar panel arrangements 28 are each connected to the guide rail arrangements 22 via support structures 30 (only those selected are provided with their own reference number).

Generally, each solar panel arrangement 28 bridges the distance A of each pair of guide rail arrangements 22 to which it is connected, thereby covering a corresponding part of the underlying open space 12. Furthermore, the solar panel arrangements 28 are lined up along the guide rail arrangements 22.

Electrical energy generated by means of the solar panel arrangements 28 can be stored in at least one electrical energy store 32 which is indicated only schematically. The processing device 24 and in particular an electrical energy store integrated there can be temporarily supplied with power or charged from this energy store 32.

For this purpose, the processing device 24 can move to a predefined position along the guide rail arrangements 22 and connect there to an electrical interface, which in turn is connected to the electrical energy store 32. FIG. 1 generally does not show any electrical line runs required therefor. However, said electrical line runs can advantageously run at least partially along and/or through the guide rail arrangements 22.

At least one optional water reservoir 34 is further shown. Like the electrical energy store 32, said water reservoir is arranged, for example, on a guide rail arrangement 22 and/or support structure 28. The processing device 24 can selectively connect to the water reservoir 34, for example, at a filling station, to fill up its own water reservoir.

At least one control device 40, for example, a control computer, is shown as a further optional component. Said control device can be integrated into any component of the system 10 depicted, for example, also into the processing device 24. Likewise, the control device 40 can comprise a plurality of interacting individual control computers, for example, a control computer for controlling the processing device 24, a control computer for controlling the energy store and/or water reservoir 32, 34 and/or a control computer for controlling the generation of energy by means of the solar panels 28. Such control computers 40 do not necessarily have to communicate with one another. Instead, they can, for example, carry out predetermined measures depending on predefined system states and/or states of the units controlled by other control computers.

Measurement or sensory survey results of the type described herein obtained by means of the processing device 24 can be transmitted to the control device 40. Instructions can also be stored by means of the control device 40, based on which work processes of the system 10 can be controlled.

During operation, the processing device 24 can carry out processing and/or surveying processes of the plants using such programmed work processes and/or, depending on the phase of plant growth, by means of any of the units described herein comprised by the processing device 24. The processing device 24 can, for example, move independently or automatically along the guide rail arrangements 22 to positions where plants and in particular rows of plants are located. Said processing device 24 can independently or automatically carry out the desired processing there.

FIG. 2 shows a single rail segment 42 in a perspective individual representation. The orientation corresponds to a rail segment 42 of the middle guide rail arrangement 22 in FIG. 1. When installed in a guide rail arrangement 22, a longitudinal axis L of the rail segment 42 coincides with the longitudinal axis L from FIG. 1 or defines its orientation accordingly.

The rail segment 42 is an elongate metal profile having a cross-sectional shape open at the top. By way of example, the cross-sectional shape in the case shown is a rectangle open at the top or a U-shaped cross section having sharp corners. The rail segment 42 has interface areas 44 at both of its ends along the longitudinal axis L for connecting to adjacent rail segments 42. By way of example only, these interface areas 44 comprise holes for the insertion of bolts.

The rail segment 42 also has a bottom surface 46 that is only partially visible. In the left part of the rail segment 42 that can be seen in FIG. 2, the bottom surface 46 is indented relative to the interface area 44 there. However, the bottom surface 46 of a rail segment 42 attached there can protrude sufficiently so that a gap-free, contiguous bottom surface can be formed.

Furthermore, the rail segment 42 comprises two sidewalls 48 extending upright from the bottom surface 46. The side walls 48 delimit a receiving area with the bottom surface 44 in which, for example, ends of the support structures 30 can be received.

A toothed rack can be attached (in particular screwed) to the outside of the right-hand side wall 42 facing the viewer, the teeth of which preferably point upwards. More precisely, the toothed rack can be attached to an upper edge profile 49, for example, by forming a positive fit therewith. For this purpose, the toothed rack can be pushed into or onto the rail segment 42 or its edge profile 49 along the longitudinal axis L, for example. Such a toothed rack can also be attached to the opposite outer wall (see edge profile 49 there). This enables the guide rail arrangement 22 to be designed so that it can guide and support a processing device 24 on both sides.

As an alternative to a toothed rack, a smooth rail can be connected to the edge profiles 49 or an upper side of the edge profile 49 (preferably larger than that shown in FIG. 2) can be used as a rail for rolling off, for example, driven wheels of the processing device 24.

The possibility of providing an electrical energy supply for the processing device 24 within the rail segments 42 or also generally within a guide rail arrangement 22 is not depicted separately. For example, a conductor rail or an inductive energy transmission device can be provided on the guide rail arrangement 22 for this purpose, the processing device 24 being able to receive electrical energy via a current collector or a corresponding inductive device.

The rail segments 42 can be produced inexpensively by forming and in particular folding a metal strip and/or can generally be designed in one piece. The rail segments 42 can be reusable after dismantling. In general, at least individual rail segments 42 or even complete guide rail arrangements 22 can remain on the open space 12 even after a partial system dismantling and can serve as planters for providing a flower strip.

In FIGS. 3 and 4, a further embodiment of a system 10 is shown in different operating states. By way of example, the system 10 has five guide rail arrangements 22, of which two adjacent ones are set up to interact to guide a processing device 24. Accordingly, there are a total of four such pairs, each of which forms a row of the system 10 within which the vegetation can be processed. The remaining components of the system 10 and in particular the solar panel arrangement 28 are designed analogously to the variant from FIG. 1.

Deviating from FIG. 1, the processing device 24 in the narrower sense, however, is formed by a movable processing head 100. Said processing head comprises any units with which any processing operations and/or sensory surveying disclosed herein are to be carried out. The processing head 100 is movably guided on at least one crossbeam 102 (in the case shown, two crossbeams 102 per row), in particular in the transverse direction relative to the guide rail arrangements 22.

To carry out processing, the crossbeams 102 with the processing head 100 guided thereon can be moved along a row (arrow X). If an adjacent row is to be processed, the processing head 100 can change to the crossbeams 102 that are present there and preferably assume a defined parking or changing position. A transverse rail section (not depicted) can be provided for this purpose, for example, which enables the processing head 100 to be moved over from one crossbeam (pair) 102 to an adjacent crossbeam (pair) 102. Alternatively, the processing head 100 or at least one of the drive mechanisms comprised therein can be suitably dimensioned so that said processing head can bridge a gap between the adjacent (crossbeams 102 (or pairs)).

FIG. 4 shows the state after the row change has been completed.

FIG. 5 shows an alternative solution for performing a row change. The system 10 there is constructed analogously to that shown in FIGS. 3-4. Said system therefore again has four processing rows, which are formed or, to put it another way, delimited by adjacent guide rail arrangements 22.

Furthermore, at least one crossbeam 102 that can be moved along the row and, by way of example, a crossbeam pair is provided for each row. The system 10, in turn, has a processing head 104 that can change between the rows and crossbeam pairs. This is done via curved track sections 106, each connecting a guide rail arrangement 22 to a guide rail arrangement 22 of an adjacent pair. The outer or respectively outer guide rail arrangements 22 of two adjacent pairs are preferably connected.

To change the row being processed, the processing head 100 (preferably when the crossbeam pair assumes a defined parking or changing position) moves in the transverse direction onto a track section 106. Said processing head then moves along this in accordance with the arrow W until said processing head reaches the adjacent row and a guide rail arrangement 22 there. Said processing head changes therefrom to a crossbeam pair in this row.

FIG. 6 shows a partial view of a system 10 designed essentially analogously to the variant from FIG. 1. The positions and extensions of the rods 16 of the ground anchors 20 are once again particularly clear in this representation.

In a deviation from FIG. 1, a preferably flexible web 108 is stretched between successive solar panel arrangements 28 (viewed along the guide rail arrangements 22). Said web can be essentially closed or net-like. Said web can protect the underlying soil area from the weather and/or (at least when the surface is closed) collect rainwater in order to direct it to a water reservoir, not depicted.

A water channel 110 can optionally be arranged on at least one outer edge of a respective solar panel arrangement 28 (see enlarged partial view in FIG. 7). Water can be routed to a water reservoir device or can be diverted in a defined manner to protect the soil by means of said water channel 110. The outer edge is preferably an expected or permanently inclined side edge or, as a result of a permanent or expected inclination of the preferably planar solar panel arrangement 28, a lower edge of the solar panel arrangement 28.

1. A system (10) for managing an agricultural open space (12), having:
at least two guide rail arrangements (11) running parallel to one another;
a processing device (24) supported on both guide rail arrangements (22) and being able to be moved along the guide rail arrangements (22);
at least one solar panel arrangement (28) arranged above the guide rail arrangements (22) and the processing device (24).

2. The system (10) according to claim 1,
wherein the solar panel arrangement (28) is supported on at least one of the guide rail arrangements (22) via at least one support structure (30).

3. The system (10) according to claim 1 or 2,
wherein the system (10) has at least one electrical energy store (32) for storing electrical energy generated by the solar panel arrangement (28); and/or
wherein the system (10) has at least one water reservoir (34) and the processing device (24) can be refilled with water from the water reservoir (34).

4. The system (10) according to any one of the preceding claims,
wherein at least two pairs of guide rail arrangements (22) are provided, and the guide rail arrangements (22) of each pair are set up to interact for guiding the processing device (24) and wherein at least part of the processing device (24) is set up to move between said pairs.

5. The system (10) according to any one of the preceding claims,
wherein the solar panel arrangement (28) at least partially covers an area within which the processing device (10) can be moved.

6. The system (10) according to any one of the preceding claims,
wherein the processing device (22) comprises at least one of the following units:
an irrigation unit for irrigating the open space;
a camera sensor for surveying the open space;
a UV-C light source for illuminating plants with UV-C light;
a weed removal device;
a humidity sensor;
a nutrient sensor;
a soil sensor, in particular for determining a humus layer thickness.

7. The system (10) according to any one of the preceding claims,
wherein the guide rail arrangements (22) each have a plurality of consecutive (42) rail segments.

8. The system (10) according to any one of the preceding claims,
wherein at least one of the guide rail arrangements (22) has a toothed rack, in which a driven gear wheel of the processing device (24) engages to generate a displacement movement; or has a rail on which a driven wheel of the processing device (24) rolls.

9. The system (10) according to any one of the preceding claims,
wherein the guide rail arrangements (22) at least in sections rest on a ground and/or are detachably held on the ground.

10. The system (10) according to any one of the preceding claims,
wherein the guide rail arrangements (22) are fastened to a ground anchor (20) which can be detached non-destructively from a soil of the open space (12).
